(19) United States
(12) Patent Application Publication
(10) Pub. No.: US 2009/0169944 A1
(43) Pub. Date: Jul. 2, 2009

(54) FUEL CARTRIDGE FOR FUEL BATTERY AND FUEL BATTERY USING THE SAME

(76) Inventors: Hiroyuki Hasebe, Kanagawa-ken (JP); Kenichi Takahashi, Kanagawa-ken (JP); Koichi Kawamura, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/066,189

(22) PCT Filed: Sep. 7, 2006
(86) PCT No.: PCT/JP2006/317786

§ 371 Date: Mar. 6, 2009

(30) Foreign Application Priority Data
Sep. 9, 2005 (JP) 2005-261815

(51) Int. Cl. H01M 8/10; H01M 2/00

(52) U.S. Cl. 429/30; 429/34

(57) ABSTRACT

A fuel cartridge (1) for a fuel battery includes a cartridge body (2) storing a liquid fuel for a fuel battery, a connection unit (3) provided at the cartridge body (2), and an identifier (4) containing information on the liquid fuel stored in the cartridge body (2). A fuel battery includes a liquid fuel supply system having a fuel battery-side connection unit for detachable connection with the cartridge-side connection unit of the fuel cartridge (1), a power generation section for generating power by being supplied with the liquid fuel from the liquid fuel supply system, and a detection unit for detecting the identifier (4) of the fuel cartridge (1).

### TECHNICAL FIELD

The present invention relates to a fuel cartridge for a fuel battery and a fuel battery using the same.

### BACKGROUND ART

In these years, attempts have been made to use a fuel battery as a power source for portable electronic equipment such as a notebook computer, a cellular phone and the like to make it possible to use them for a long time without recharging. The fuel battery has characteristics that electricity can be generated by merely supplying a fuel and air and generated continuously for a long time by replenishing the fuel. Therefore, the fuel battery is a very advantageous system as a power source for portable electronic equipment if it can be made compact.

A direct methanol fuel cell (DMFC) using a methanol fuel having a high energy density can be made compact and the fuel can also be handled with ease, therefore the DMFC is promising as the power source for portable appliances. As a supply method of the liquid fuel of the DMFC, there are known active methods such as a gas supply type, a liquid supply type and the like, and passive methods such as an inside vaporization type which supply the liquid fuel from a fuel tank to a fuel electrode by vaporizing in the battery cells. Among them, the active method can provide high output (high electric power) to the DMFC, so that it is expected as the power source for the notebook computer and the like.

The passive method such as the inside vaporization type does not need an active fuel transfer means such as a fuel pump, so that it is particularly advantageous for miniaturization of the DMFC. For example, Patent document 1 and Patent document 2 describe a passive DMFC comprising a fuel permeating layer which holds a liquid fuel and a fuel vaporization layer which diffuses the vaporization component of the liquid fuel which is held in the fuel permeating layer to supply to the fuel electrode. The passive DMFC is expected to the power source for a small portable appliance such as a portable audio player and a cellular phone.

The active DMFC supplies a liquid fuel to a fuel battery cell by connecting the fuel cartridge which stores the liquid fuel to the fuel battery body and circulating the liquid fuel from the fuel cartridge directly or via a fuel tank (a dilution adjusting tank or the like). The active DMFC uses as the liquid fuel an aqueous methanol solution having a concentration of about 5 to 50% depending on the structure and characteristics of the fuel battery cell. The liquid fuel supplied from the fuel cartridge is generally an aqueous methanol solution which is adjusted to have a desired concentration, but pure methanol is occasionally supplied depending on a fuel battery body-side dilution adjusting mechanism or the like. Therefore, there coexist fuel cartridges storing methanols having various concentrations.

The inside vaporization type passive DMFC has a mechanism for vaporization of the liquid fuel and a fuel tank, and the fuel cartridge is used in the same manner as the active DMFC to supply the liquid fuel to the fuel tank. For further downsizing of the passive DMFC, studies and practical use of the DMFC using pure methanol as the liquid fuel are underway. The aqueous methanol solution is also used depending on the structure, characteristics and the like of the fuel battery cell in the same manner as the active DMFC. Therefore, there also coexist the fuel cartridges for the passive DMFC in a state of storing, for example, a range of from an aqueous methanol solution having a concentration of 50% or more to pure methanol.

As described above, both the active and passive DMFCs have fuel cartridges which store liquid fuels of various concentrations. Since the DMFC is designed to exert the initial characteristics by using a liquid fuel of a prescribed concentration, the output characteristics are degraded if the liquid fuel has a different concentration. Especially, since the inside vaporization type passive DMFC operates on the vaporization component of the directly vaporized liquid fuel, the concentration of the liquid fuel has a great influence upon the output characteristics of the DMFC. In addition, when a liquid fuel having a concentration higher than the preset concentration is used, the output characteristics might be degraded conversely.
[Patent Document 1] Japanese Patent No. 3413111
[Patent Document 2] JP-A 2004-171844 (KOKAI)

### SUMMARY OF THE INVENTION

According to an aspect of the present invention, there are provided a fuel cartridge for a fuel battery that can prevent degradation of characteristics and occurrence of defects of the fuel battery due to mismatching of a liquid fuel, and also a fuel battery applying such a fuel cartridge for a fuel battery.

A fuel cartridge for a fuel battery according to an aspect of the present invention includes: a cartridge body storing a liquid fuel for the fuel battery; a connection unit, provided with the cartridge body, supplying the liquid fuel to the fuel battery; and an identifier containing information on the liquid fuel stored in the cartridge body.

A fuel battery according to another aspect of the present invention includes: a fuel cartridge for a fuel battery which comprises a cartridge body for storing a liquid fuel, a cartridge-side connection unit disposed on the cartridge body, and an identifier containing information on the liquid fuel stored in the cartridge body; and a fuel battery body which comprises a liquid fuel supply system having a fuel battery-side connection unit for detachable connection with the cartridge-side connection unit, a power generation section for performing a power generation operation according to supply of the liquid fuel from the liquid fuel supply system, and a detection unit for detecting the identifier of the fuel cartridge.

### BRIEF DESCRIPTION OF THE DRAWINGS

FIG. 1 is a front view showing a structure of a fuel cartridge for a fuel battery according to an embodiment of the present invention.

FIG. 2 is a diagram partly showing a structure of a modified example of the fuel cartridge shown in FIG. 1.

FIG. 3 is a diagram partly showing a structure of another modified example of the fuel cartridge shown in FIG. 1.

FIG. 4 is a diagram partly showing a structure of still another modified example of the fuel cartridge shown in FIG. 1.

FIG. 5 is a sectional view showing a structure of a fuel battery according to an embodiment of the present invention.

FIG. 6 is a sectional view showing a non-connected state of a connection unit portion which connects a fuel cartridge to the fuel battery shown in FIG. 5.

FIG. 7 is a sectional view showing a connected state of the connection unit portion shown in FIG. 6.

### EXPLANATION OF REFERENCE NUMERALS

1: Fuel cartridge for fuel battery, 2: cartridge body, 3: cartridge-side connection unit (nozzle portion), 4: identifier, 5: noncontact data carrier part, 8: optical pattern, 9: conductor pattern, 10: irregular pattern, 20: DMFC (fuel battery body), 21: fuel storing portion, 22: fuel battery cell, 23: gas selectively permeable membrane, 31: fuel battery-side connection unit (socket portion), 36: detection unit.

### MODE FOR CARRYING OUT THE INVENTION

Modes of conducting the present invention will be described below with reference to the drawings. Embodiments of the present invention are described with reference to the drawings, which are provided for illustration only, and the present invention is not limited to the drawings.

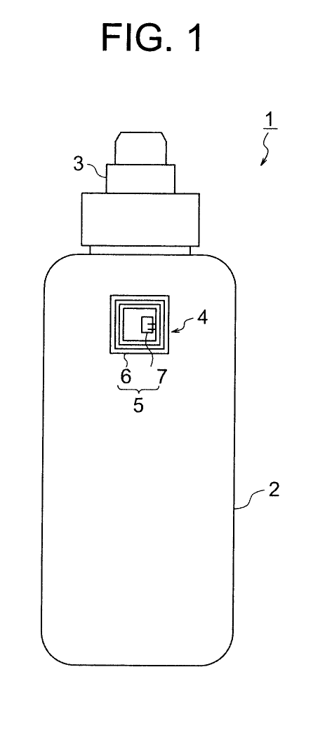

FIG. 1 is a front view showing a structure of a fuel cartridge for a fuel battery according to an embodiment of the present invention. A fuel cartridge 1 shown in the drawing has a cartridge body 2 for storing a liquid fuel. A leading end of the cartridge body 2 is provided with a connection unit 3 for supplying the liquid fuel to the fuel battery. The cartridge-side connection unit 3 configures a pair of connection mechanism portions together with a fuel battery-side connection unit as described later in detail. For example, a nozzle part of a coupler which is comprised of a nozzle and a socket is applied as the connection unit 3. Details of the connection mechanism are described later.

The cartridge body 2 stores the liquid fuel matching the fuel battery applying the fuel cartridge 1. For the direct methanol fuel cell (DMFC), a methanol fuel such as aqueous methanol solutions having various concentrations, pure methanol or the like is stored. The liquid fuel to be stored in the cartridge body 2 is not limited to the methanol fuel but may be an ethanol fuel such as an aqueous ethanol solution, pure ethanol or the like, a propanol fuel such as an aqueous propanol solution, pure propanol or the like, a glycol fuel such as an aqueous glycol solution, pure glycol or the like, dimethyl ether, formic acid, or another liquid fuel. In any case, the liquid fuel matching the fuel battery is stored.

For the DMFC, methanol fuels of various concentrations, for example, an aqueous methanol solution having a concentration of 10% or more and less than 100%, pure methanol or the like, are used. The concentration of the methanol fuel is decided depending on the structure, characteristics and the like of the fuel battery cell of the DMFC, so that the fuel cartridge 1 which stores the methanol fuels of various concentrations is required. When such various types of fuel cartridges 1 are present in mixture, there is a possibility of occurrence of a human error in fuel selection or the like.

As described above, the fuel battery represented by the DMFC is designed to exert initial characteristics by using a prescribed liquid fuel, so that if a type, a concentration or the like of the liquid fuel is different, there is a possibility of degrading the output characteristics and also causing various problems. To prevent the occurrence of such degradation of the output characteristics and the occurrence of problems, the fuel cartridge 1 according to this embodiment has the cartridge body 2 provided with an identifier 4 containing information on the liquid fuel.

For example, in a case where the liquid fuel stored in the cartridge body 2 is a methanol fuel, the identifier 4 contains concentration information on the methanol fuel in addition to type information indicating that the liquid fuel is the methanol fuel. By applying the identifier 4, even if there coexist the fuel cartridges 1 storing methanol fuels of various concentrations, degradation of output characteristics and occurrence of various problems due to mismatching of the liquid fuel caused by human error of selection can be prevented. The same is also applied to the liquid fuels other than the methanol fuel.

The information on the liquid fuel possessed by the identifier 4 is not limited to the type information (such as a methanol fuel or not) and the concentration information (such as the concentration information on the methanol fuel) on the liquid fuel. The identifier 4 may contain volume information and purity information on the liquid fuel stored in the cartridge body 2, a code indicating a legally approved product, and the like. The identifier 4 may be limited to inclusion of the above types of information only depending on the circumstances. In addition, the identifier 4 may contain information whether the connection unit 3 of the fuel cartridge 1 can be connected to a fuel battery-side connection unit.

The identifier 4 is, for example, a noncontact data carrier part 5 shown in FIG. 1. The data carrier part 5 is mainly comprised of an antenna 6 and a semiconductor device 7 which stores information, and its known examples include an RF tag, a noncontact IC card and the like. The data carrier part 5 receives an electromagnetic wave, which is transmitted from external equipment (a reader/writer device or the like), by the antenna 6 to generate operation power and also sends/receives information stored in the semiconductor device 7 to/from the external equipment. Therefore, the liquid fuel information stored in the data carrier part 5 can be sent to the fuel battery by the reader/writer device or the like which is disposed as a detection unit of the data carrier part 5 on the side of the fuel battery.

It is judged on the side of the fuel battery whether the fuel information sent from the data carrier part 5 matches the fuel battery. For example, a mechanism that allows to accept the liquid fuel or allows to supply the liquid fuel to the fuel battery cell only when the judged result is appropriate is previously incorporated into the fuel battery, so that degradation of characteristics, a failure of the device, various failures due to mismatching of a type, a concentration and the like of the liquid fuel can be prevented from occurring.

The fuel battery may be configured such that if a level of defects because of the supply of an incorrect liquid fuel to the fuel battery is minor, the judged result whether information on the liquid fuel matches is indicated by an indication lamp or the like. The fuel battery is not essential to have a mechanism of physically stopping the supply of the liquid fuel, such as a liquid fuel blocking mechanism or a mechanism of preventing the connection of the connection unit.

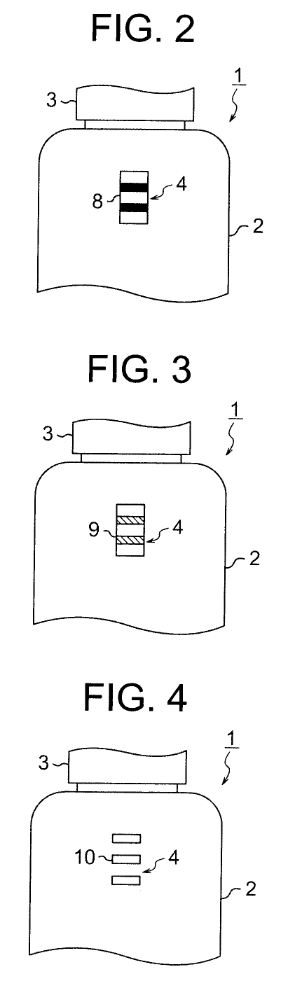

Referring to FIG. 1, an example of using the noncontact data carrier part 5 as the identifier 4 has been described, but the identifier 4 is not limited to it. FIG. 2 shows the fuel cartridge 1 with an optical pattern 8 disposed as the identifier 4 on the cartridge body 2. FIG. 3 shows the fuel cartridge 1 using a conductor pattern 9 as the identifier 4, and FIG. 4 shows the fuel cartridge 1 using an irregular pattern 10 as the identifier 4.

The optical pattern 8 as the identifier 4 has a combination (e.g., a black and white pattern or a geometrical pattern) of at least two types of patterns having a different reflectance and indicates information such as a type, a concentration and the like of the liquid fuel. Specific examples of the optical pattern 8 include a bar code, a QR code and the like. The optical pattern 8 may be printed directly on the cartridge body 2, or a sealing or the like on which the optical pattern 8 is printed may be applied to the cartridge body 2. As a detection unit for the optical pattern 8, an optical reader (a scanner, an image reading device or the like) is provided on the side of the fuel battery, so that information on the liquid fuel contained in the optical pattern 8 can be sent to the fuel battery.

The conductor pattern 9 as the identifier 4 has at least two patterns (e.g., a combination of a conductive pattern and an insulation pattern) having different electric conductivity and indicates information such as a type, a concentration and the like of the liquid fuel. The conductor pattern 9 may be formed directly on the cartridge body 2, or a sealing or the like on which the conductor pattern 9 is formed may be applied to the cartridge body 2. As the detection unit for the conductor pattern 9, an electrode or the like for checking conduction is disposed on the side of the fuel battery, so that information on the liquid fuel contained in the conductor pattern 9 can be sent to the fuel battery.

An irregular pattern 10 as the identifier 4 has at least two patterns (e.g., a projected portion and a recessed portion, a projected portion and a plane surface portion, a plane surface portion and a recessed portion, and the like) having a different height and indicates information such as a type, a concentration and the like of the liquid fuel. The irregular pattern 10 may be engraved directly in the cartridge body 2, or a sealing or the like on which the irregular pattern 10 is formed may be applied to the cartridge body 2. As the detection unit for the irregular pattern 10, an optical reader, a contact type scanning device or the like is disposed on the side of the fuel battery, so that information on the liquid fuel contained in the irregular pattern 10 can be sent to the fuel battery.

As described above, various identifiers 4 can be used to send information on the liquid fuel contained in the fuel cartridge 1 to the fuel battery. And, it is judged on the side of the fuel battery whether the liquid fuel information matches regardless of which identifier 4 is used, so that a mismatching of the liquid fuel due to human error in selection of the fuel cartridge 1 or the like and the resulting degradation of output characteristics and various failures can be prevented from occurring. Therefore, when the fuel cartridge 1 having the identifier 4 of this embodiment is applied, a fuel battery system excelling in output characteristics, reliability and the like can be configured. The structure of the fuel battery is not limited to a particular one.

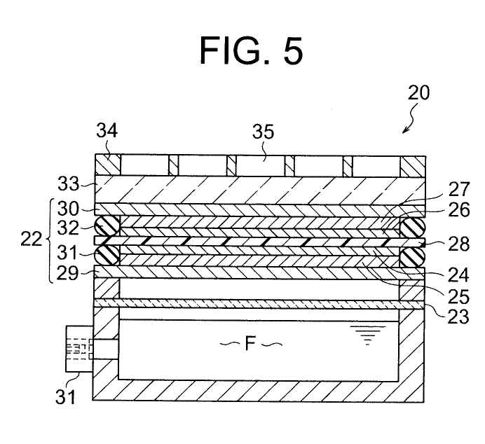

The fuel battery according to an embodiment of the present invention is described below with reference to FIG. 5. FIG. 5 is a sectional view showing a main portion structure of the embodiment that the fuel battery of the present invention is applied to a passive (inside vaporization type) DMFC. A passive DMFC 20 shown in FIG. 5 is mainly comprised of a fuel storing portion 21 as a liquid fuel supply system, a fuel battery cell 22 which configures a power generation section, and a gas selectively permeable membrane 23 which is disposed therebetween.

The fuel battery cell 22 has a membrane electrode assembly (MEA) which is comprised of an anode (fuel electrode) having an anode catalyst layer 24 and an anode gas diffusion layer 25, a cathode (oxidant electrode/air electrode) having a cathode catalyst layer 26 and a cathode gas diffusion layer 27, and a proton (hydrogen ion) conductive electrolyte membrane 28 which is held between the anode catalyst layer 24 and the cathode catalyst layer 26.

The catalyst contained in the anode catalyst layer 24 and the cathode catalyst layer 26 includes, for example, a sole platinum group element such as Pt, Ru, Rh, Ir, Os or Pd, an alloy containing the platinum group elements, or the like. Pt—Ru, Pt—Mo or the like having high resistance to methanol and carbon monoxide is preferably used for the anode catalyst layer 24. Pt, Pt—Ni or the like is preferably used for the cathode catalyst layer 26. The catalyst may be a supported catalyst using a conductive carrier such as carbon material, or a non-supported catalyst.

The proton conductive material configuring the electrolyte membrane 28 includes, for example, a fluorine-based resin (Nafion (brand name; manufactured by DuPont) or Flemion (brand name; manufactured by Asahi Glass Co.) or the like)) such as a perfluorosulfonic acid polymer having a sulfonic acid group, a hydrocarbon-based resin having a sulfonic acid group, and an inorganic substance such as tungsten acid, phosphotungstic acid or the like. But, the component materials of the proton conductive electrolyte membrane 28 are not limited to the above.

The anode gas diffusion layer 25 which is laminated on the anode catalyst layer 24 plays a role to supply uniformly the fuel to the anode catalyst layer 24 and also serves as a power collector of the anode catalyst layer 24. The cathode gas diffusion layer 27, which is laminated on the cathode catalyst layer 26, plays a role to supply uniformly an oxidizing agent to the cathode catalyst layer 26 and also serves as a power collector of the cathode catalyst layer 26.

An anode conductive layer 29 is laminated on the anode gas diffusion layer 25, and a cathode conductive layer 30 is laminated on the cathode gas diffusion layer 27. The conductive layers 29, 30 are configured of a mesh, a porous membrane, a thin film or the like which is formed of a conductive metallic material such as gold. Rubber O-rings 31, 32 are interposed between the electrolyte membrane 28 and the anode conductive layer 29 and between the electrolyte membrane 28 and the cathode conductive layer 30 to prevent the fuel and the oxidizing agent from leaking from the fuel battery cell (MEA) 22.

A methanol fuel or the like is filled as a liquid fuel F in the fuel storing portion 21 such as the fuel tank or the like. The fuel storing portion 21 has a fuel battery-side connection unit 31 as a mechanism for externally supplying the liquid fuel F when the liquid fuel F in it is exhausted. By connecting the connection unit 3 of the fuel cartridge 1 of the above-described embodiment to the connection unit 31 disposed on the fuel storing portion 21, it possible to supply the liquid fuel from the fuel cartridge 1 into the fuel storing portion 21.

The fuel storing portion 21 is disposed on the side of the anode (fuel electrode) of the fuel battery cell (MEA) 22. The fuel storing portion 21 has a box-like container for storing the liquid fuel F with its side facing the anode (fuel electrode) open. The gas selectively permeable membrane 23 is disposed between the opening portion of the fuel storing portion 21 and the fuel battery cell 22. The gas selectively permeable membrane 23 is a vapor-liquid separating film which allows the passage of only the vaporization component of the liquid fuel F but does not allows the passage of the liquid component.

The component materials of the gas selectively permeable membrane 23 include, for example, fluorine resin such as polytetrafluoroethylene. Only the vaporization component of the liquid fuel F is supplied to the fuel battery cell 22 through the gas selectively permeable membrane 23. The vaporization component of the liquid fuel F means a gas mixture which consists of a vaporization component of methanol and a vaporization component of water when the aqueous methanol solution is used as the liquid fuel F, and means a vaporization component of methanol when pure methanol is used.

A moisture retaining layer 33 is laminated on the cathode conductive layer 30, and a surface layer 34 is laminated on the moisture retaining layer 33. The surface layer 34 has a function to adjust an introduced volume of air which is an oxidizing agent, and its adjustment is performed by changing the quantity, size and the like of air introduction ports 35 formed in the surface layer 34. The moisture retaining layer 33 plays a role of suppressing water evaporation by partial impregnation of water generated by the cathode catalyst layer 26, and also has a function to promote uniform diffusion of the oxidizing agent to the cathode catalyst layer 26 by uniform introduction of the oxidizing agent into the cathode gas diffusion layer 27. For example, the moisture retaining layer 33 is formed of a member having a porous structure, and specific component materials include a porous body or the like of polyethylene or polypropylene.

According to the passive DMFC (fuel battery body) 20 having the structure described above, the liquid fuel F (e.g., the aqueous methanol solution) in the fuel storing portion 21 is vaporized, and the vaporization component is supplied to the fuel battery cell 22 through the gas selectively permeable membrane 23. In the fuel battery cell 22, the vaporization component of the liquid fuel F is diffused by the anode gas diffusion layer 25 and supplied to the anode catalyst layer 24. The vaporization component supplied to the anode catalyst layer 24 causes an internal reforming reaction of methanol expressed by the following formula (1).

CH₃OH+H₂O→CO₂+6H⁺+6e⁻ (1)

When pure methanol is used as the liquid fuel F, steam is not supplied from the fuel storing portion 21, so that water produced by the cathode catalyst layer 26 and water in the electrolyte membrane 28 are reacted with methanol to cause the internal reforming reaction of the formula (1). Otherwise, an internal reforming reaction is caused by another reaction mechanism not requiring water without depending on the above-described internal reforming reaction of the formula (1).

Proton (H⁺) produced by the internal reforming reaction reaches the cathode catalyst layer 26 through the electrolyte membrane 28. Air (oxidizing agent) introduced through the air introduction port 35 of the surface layer 34 is diffused into the moisture retaining layer 33, the cathode conductive layer 30 and the cathode gas diffusion layer 27 and supplied to the cathode catalyst layer 26. The air supplied to the cathode catalyst layer 26 causes the reaction expressed by following formula (2). This reaction causes a power generation reaction involving the generation of water.

(3/2)O₂+6H⁺+6e⁻→3H₂O (2)

With the progress of the power generation reaction based on the above-described reaction, the liquid fuel F (e.g., an aqueous methanol solution and pure methanol) in the fuel storing portion 21 is consumed. When the liquid fuel F in the fuel storing portion 21 is exhausted, the power generation reaction stops, so that the liquid fuel is supplied from the fuel cartridge 1 into the fuel storing portion 21 at that time or before that.

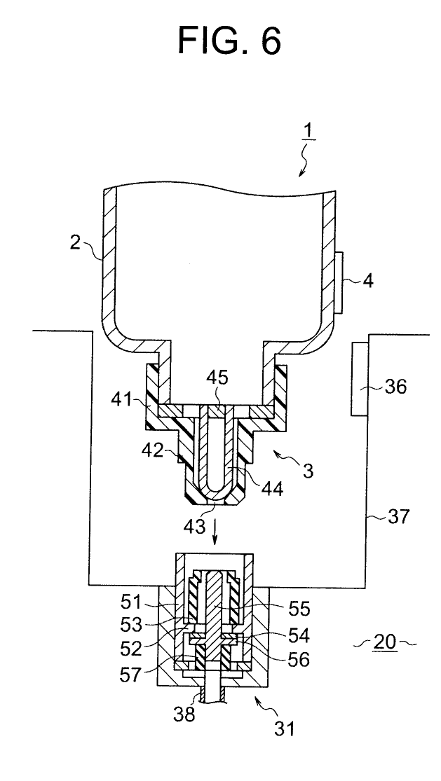

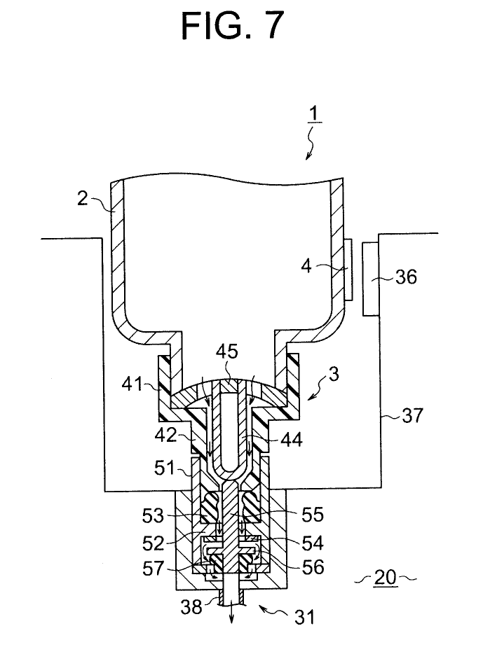

The supply of the liquid fuel from the fuel cartridge 1 is performed by connecting the cartridge-side connection unit 3 to the fuel battery-side connection unit 31. The cartridge-side and fuel battery-side connection units 3, 31 configure a pair of connection mechanism portions such as a coupler. FIG. 6 and FIG. 7 are sectional views showing a connection mechanism portion using the coupler in a magnified form. Here, a nozzle part is applied to the cartridge-side connection unit 3, and a socket part is applied to the fuel battery-side connection unit 31.

FIG. 6 shows a state before the nozzle portion 3 and the socket portion 31 are connected, and FIG. 7 shows a state that they are connected. The nozzle portion 3 as the cartridge-side connection unit shown in the drawings has a nozzle body 41, a nozzle portion 42, a nozzle opening 43, a movable pin 44 and a flange-shaped support member 45. The socket portion 31 as the fuel battery-side connection unit has a housing 51, a ring-shaped projected portion 52, a collar 53, a ring-shaped packing 54, a valve stem 55, a valve head 56 and a cylindrical support member 57.

In the connection unit (nozzle portion) 3 of the fuel cartridge 1, the nozzle body 41 has the nose portion 42, and the nozzle opening 43 is formed at the leading end of the nose portion 42. The movable pin 44 is housed in the cylindrical nose portion 42. The movable pin 44 is movable in the axial direction. The movable pin 44 is configured to block the nozzle opening 43 at its forwarded position to close the passage in the nozzle and to separate from the nozzle opening 43 at its retreat position so as to open the passage in the nozzle.

The rear end portion of the movable pin 44 is fixed to the nozzle body 41 via the flange-shaped support member 45 which is formed of an elastic member such as rubbers and thermoplastic elastomers. When the nozzle portion 3 is separated from the socket portion 31, the flange-shaped support member 45 pushes the movable pin 44 into an advanced position to close the passage in the nozzle portion 3.

In the connection unit (socket portion) 31 of the fuel battery (DMFC) 20, the housing 51 has a substantially cylindrical shape with the ring-shaped projected portion 52 formed to protrude inward in the radial direction on its inner circumferential surface at an intermediate position in the axial direction. In the housing 51, the collar 53 formed of an elastic material is inserted into a portion (the inlet side of the socket portion 31) on the outside in the axial direction of the projected portion 52. The rear end surface of the collar 53 is supported by a side surface of the outer side (on the inlet side of the socket portion 31) of the projected portion 52.

In the housing 51, the ring-shaped packing 54 is inserted into a portion (a deep portion of the socket portion 31) in the axial direction of the projected portion 52. The back surface of the ring-shaped packing 54 is supported by the side surface of the inner side (a deep portion of the socket portion 3) of the projected portion 52. The valve stem 55 is housed in the cylindrical space which is formed in the collar 53, the projected portion 52 and the ring-shaped packing 54. The valve stem 55 is movable in the axial direction. The valve head 56 is attached in the vicinity of the rear end of the valve stem 55.

The valve head 56 is configured to come into contact with the ring-shaped packing 54 to close the passage in the socket portion 31 when the valve stem 55 is at the advanced position and to separate from the ring-shaped packing 54 to open the passage in the socket portion 31 when the valve stem 55 is at the retreat position. The rear end of the valve stem 55 is supported by the housing 51 via the cylindrical support member 57 formed of an elastic material. When the nozzle portion 3 is separated from the socket portion 31, the cylindrical support member 57 pushes in the valve head 56 to close the passage in the socket portion 31.

When the nozzle portion 3 is attached to the socket portion 31, the nose portion 42 is contacted to the front end surface of the collar 53 to seal the connected portion between the nozzle body 41 and the housing 51 as shown in FIG. 7. In addition, the collar 53 is compressed by the nose portion 42, the valve stem 55 strikes against the movable pin 44, and the movable pin 44 is pushed into the retreat position. Thus, the passage in the nozzle portion 3 is opened. Meanwhile, the valve stem 55 is pushed into the retreat position by the movable pin 44 which has stopped at the retreat position, and the passage in the socket portion 31 is opened.

Information on a type, a concentration and the like of the liquid fuel in the fuel cartridge 1 is included in the identifier 4. The detection unit 36 for detecting the information of the identifier 4 is disposed on the side of the fuel battery 20. As the detection unit 36, a reader/writer device is used when the identifier 4 is the data carrier part 5 shown in FIG. 1. As the detection unit 36, an optical scanning device is disposed when the identifier 4 is the optical pattern 8 shown in FIG. 2, an electrode mechanism is disposed when it is the conductor pattern 9 shown in FIG. 3, and an optical scanning device, a contact type scanning device or the like is disposed when it is the irregular pattern 10 shown in FIG. 4.

For example, the detection unit 36 is disposed on a guide portion 37 of the fuel battery 20 for guiding the insertion of the nozzle portion 3. An installation position of the detection unit 36 is determined according to the position of detecting the information of the identifier 4. In other words, in a case where the information of the identifier 4 is detected when the nozzle portion 3 is connected to the socket portion 31, the detection unit 36 is disposed such that the detection unit 36 is close or contacted to the identifier 4 of the connected fuel cartridge 1 as shown in FIG. 7.

In a case where the information of the identifier 4 is detected before the nozzle portion 3 is connected to the socket portion 31, the detection unit 36 is disposed so to come close to or contact to the identifier 4 before the fuel cartridge 1 is moved forward. In whichever case, the detection unit 36 of the fuel battery 20 detects the information (type information, concentration information and the like) on the liquid fuel sent from the identifier 4 and judges whether the fuel information matches the fuel battery.

Thus, it is judged according to the identifier 4 whether the liquid fuel in the fuel cartridge 1 matches the fuel battery 20. Thus, mismatching of the liquid fuel due to human error of selecting the fuel cartridge 1, degradation of output characteristics or occurrence of defects because of the error can be prevented. Therefore, a fuel battery system excelling in output characteristics, reliability and the like, namely a fuel battery system which is comprised of the fuel cartridge 1 and the fuel battery 20 can be provided.

The judged result of the fuel information contained in the identifier 4 of the fuel cartridge 1 may be indicated by means of, for example, an indication lamp for indicating correct or not. But, it is desirable to apply a mechanism of blocking the supply of the liquid fuel from the fuel cartridge 1 into the fuel storing portion 21 or a mechanism of preventing the connection between the nozzle portion 3 of the fuel cartridge 1 and the socket portion 31 of the fuel battery 20.

For example, a fuel blocking mechanism such as a valve mechanism (not shown) is disposed at the middle of a fuel pipe 38 from the socket portion 31 to the fuel storing portion 21. The valve mechanism is put in an open state only when the judged result of the fuel information is correct, so that an incorrect liquid fuel can be prevented from being supplied into the fuel storing portion 21. For example, the fuel blocking mechanism may be a mechanism which controls the valve operation in the socket portion 31 or prevents the connection between the nozzle portion 3 and the socket portion 31. Fuel supply from the fuel storing portion 21 to the fuel battery cell 22 may be blocked depending on the circumstances.

Described in the above-described embodiment is an example of applying the fuel battery (fuel battery system) of the present invention to the passive fuel battery, but the present invention is not limited to it. The present invention can also be applied to the active fuel battery. When the fuel battery of the present invention is a fuel battery which supplies the liquid fuel by means of the fuel cartridge, it is not limited by its method and mechanism.

In a case where the fuel battery (fuel battery system) of the present invention is applied to the active fuel battery, the connection unit portion, which is comprised of the fuel battery-side connection unit disposed on the liquid fuel supply system having the fuel pump and the fuel cartridge-side connection unit, is provided with the detection unit of the identifier, a liquid fuel blocking mechanism according to the detected results, and the like. The active fuel battery has a case that the liquid fuel is circulated from the fuel cartridge via the fuel storing portion (including the dilution adjusting tank and the like) and a case that the liquid fuel is circulated directly from the fuel cartridge, and the present invention can be applied to both of them.

### INDUSTRIAL APPLICABILITY

The fuel cartridge for a fuel battery according to the embodiment of the present invention clarifies the information such as a type, a concentration and the like of the liquid fuel stored in it. Therefore, the application of the fuel cartridge for a fuel battery can provide a fuel battery that prevents degradation of characteristics and occurrence of defects due to mismatching of the liquid fuel. The fuel cartridge according to the embodiment of the present invention is effectively used for various types of fuel batteries.

What is claimed is:

1. A fuel cartridge for a fuel battery, comprising:
a cartridge body storing a liquid fuel for the fuel battery;
a connection unit, provided with the cartridge body, supplying the liquid fuel to the fuel battery; and
an identifier containing information on the liquid fuel stored in the cartridge body.

2. The fuel cartridge for a fuel battery according to claim 1, wherein the identifier includes a noncontact data carrier part.

3. The fuel cartridge for a fuel battery according to claim 1, wherein the identifier includes an optical pattern formed on the cartridge body.

4. The fuel cartridge for a fuel battery according to claim 1, wherein the identifier includes a conductor pattern formed on the cartridge body.

5. The fuel cartridge for a fuel battery according to claim 1, wherein the identifier includes an irregular pattern formed on the cartridge body.

6. The fuel cartridge for a fuel battery according to claim 1, wherein the liquid fuel is a methanol fuel and the identifier contains type information and concentration information on the methanol fuel.

7. A fuel battery, comprising:
a fuel cartridge for a fuel battery which comprises a cartridge body for storing a liquid fuel, a cartridge-side connection unit disposed on the cartridge body, and an identifier containing information on the liquid fuel stored in the cartridge body; and
a fuel battery body which comprises a liquid fuel supply system having a fuel battery-side connection unit for detachable connection with the cartridge-side connection unit, a power generation section for performing a power generation operation according to supply of the liquid fuel from the liquid fuel supply system, and a detection unit for detecting the identifier of the fuel cartridge.

8. The fuel battery according to claim 7, wherein the identifier includes a noncontact data carrier part, an optical pattern, a conductor pattern or an irregular pattern.

9. The fuel battery according to claim 7, wherein the liquid fuel is a methanol fuel and the identifier contains type information and concentration information on the methanol fuel.

10. The fuel battery according to claim 7, further comprising:
a fuel blocking mechanism which blocks the supply of the liquid fuel from the fuel cartridge to the liquid fuel supply system according to the information of the identifier detected by the detection unit.

11. The fuel battery according to claim 7, wherein the power generation section is provided with a fuel electrode, an oxidant electrode, and an electrolyte membrane which is held between the fuel electrode and the oxidant electrode.

12. The fuel battery according to claim 11, wherein the liquid fuel supply system includes a fuel storing portion which has the fuel battery-side connection unit, and a gas selectively permeable membrane, interposed between the fuel storing portion and the power generation section, supplying a vaporization component of the liquid fuel to the fuel electrode.
